(19) United States
(12) Patent Application Publication
(10) Pub. No.: US 2008/0098916 A1
(43) Pub. Date: May 1, 2008

(54) JACKET FOR IMPRESSION CYLINDER OR TRANSPORT CYLINDER OF PRINTING PRESS

(75) Inventor: Seiichiro INOUE, Tsukuba-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/923,394

(22) Filed: Oct. 24, 2007

(30) Foreign Application Priority Data
Oct. 25, 2006 (JP) 2006-289545

(51) Int. Cl. B41F 22/00

(52) U.S. Cl. 101/422

(57) ABSTRACT

Disclosed is a jacket for any one of an impression cylinder and a transport cylinder of a printing press, which jacket is wound around any one of the impression cylinder and the transport cylinder of a printing press so as to prevent ink from adhering to the cylinder, the jacket produced by plating the front side of a sheet-shaped base having convex and concave portions thereon with a metal having ink-repellent particles dispersed therein, in a manner that the convex and concave portions on the front side of the sheet-shaped base are left.

### BACKGROUND OF THE INVENTION

1. Field of the Invention

The present invention relates to a jacket that is to be wound around an impression cylinder or a transport cylinder of a printing press so as to prevent ink from adhering to the impression cylinder or the transport cylinder.

2. Description of the Related Art

Suppose a case where prints are made on two sides of a sheet, such as paper or cloth, by using a perfecting press, such as a sheet-fed perfecting press. In this case, when a print of the second or subsequent color is to be made, the sheet is pressed against a blanket cylinder by an impression cylinder from a side on which a print has just been made, so that the other side of the sheet is brought into contact with the blanket cylinder. Accordingly, ink adheres to the impression cylinder, and then the ink, having adhered to the impression cylinder, adheres further to another printing product (another sheet, such as paper) that comes next. As a result, the printing product may be smeared to be a failure.

Such a problem is not limited to the perfecting press, but may occur also in a convertible perfecting press having a function of sequentially making prints on the front and back sides of a sheet of paper. Specifically, the problem may occur in making a print on the back side of a sheet of paper by reversing the sheet after a print is made on the front side thereof. In addition, in the case of the perfecting press, although not as serious as the case of the impression cylinder, the smearing of printing products may occur also in the transport cylinder (the transfer cylinder).

For the purpose of preventing such smearing of printing products, a plate having an ink-repellent surface or the like has conventionally been used. This plate is wound around the surface of a transport cylinder or an impression cylinder, which is brought into contact with a printed side of a printing product, of a sheet-fed printing press. Accordingly, the ink, applied to the printing product, is prevented from adhering to the surface of the cylinder. Such a plate has been disclosed, for example, in Japanese Unexamined Patent Application Publication No. Hei 3-120048.

The plate disclosed in Japanese Unexamined Patent Application Publication No. Hei 3-120048 is obtained by forming an ink-repellent silicone layer on a surface of a support member made of nickel or chrome, and having hemispherical protrusions formed on the surface. Since the silicone layer is relatively soft, separation and wear are likely to occur therein, and also paper dust and debris are likely to stick thereinto. In addition, since the silicone layer has poor electrostatic characteristics and is likely to be charged, paper dust and debris adhere to the surface thereof, leading to the occurrence of ink smearing. Accordingly, the plate needs to be frequently washed, and further replaced. As a result, a heavy burden is imposed on the operator, and the productivity is thus decreased. Moreover, the silicone is likely to be swelled, and has poor resistance to solvents. For this reason, there is a limitation in the washing of the silicone with a solvent.

### SUMMARY OF THE INVENTION

The present invention has been made in view of the above-described circumstances associated with the conventional jacket, and an object of the present invention is to provide a jacket for an impression cylinder or a transport cylinder, which jacket provides, to the impression cylinder or the transport cylinder, not only the resistance to the adhesion of ink but also durability and resistance to solvents, while paper dust and the like are unlikely to adhere to the jacket.

The present invention provides a jacket for any one of an impression cylinder and a transport cylinder of a printing press, which jacket is wound around any one of an impression cylinder and a transport cylinder of a printing press so as to prevent ink from adhering to the cylinder. The jacket is produced by plating the front side of a sheet-shaped base having convex and concave portions thereon with a metal having ink-repellent particles dispersed therein, in a manner that the convex and concave portions on the front side of the sheet-shaped base are left.

The ink-repellent particles may be made of, for example, a modified fluororesin. As a concrete example of the modified fluororesin for the particles, tetrafluoroethylene resin may be given. For such ink-repellent particles, artificial diamond may also be used.

In addition, the jacket for an impression cylinder or a transport cylinder of a printing press, according to the present invention, also provides the following characteristics.

Specifically, the back side of the sheet-like base is plated with a metal having ink-repellent particles dispersed therein.

### BRIEF DESCRIPTION OF THE DRAWINGS

The present invention will become more fully understood from the detailed description given hereinbelow and the accompanying drawings which are given by way of illustration only, and thus are not limitation of the present invention, and wherein:

FIG. 1 shows a cross-sectional view of a part of a jacket, according to a first embodiment of the present invention, for an impression cylinder or a transport cylinder of a printing press;

FIG. 2 shows a cross-sectional view of a part of a jacket, according to a second embodiment of the present invention, for an impression cylinder or a transport cylinder of a printing press;

FIG. 3 shows a schematic cross-sectional view of an example of a printing press provided with impression cylinders and a transport cylinder, for which the jacket according to the present invention is to be used;

FIG. 4 shows a schematic view for explaining how ink adheres to an impression cylinder; and

FIG. 5 shows a schematic view of an impression cylinder or a transport cylinder, on which the jacket is mounted.

### DETAILED DESCRIPTION OF THE INVENTION

Hereinafter, a jacket for an impression cylinder or a transport cylinder of a printing press, according to the present invention, will be described in detail with reference to the accompanying drawings.

### Embodiment 1

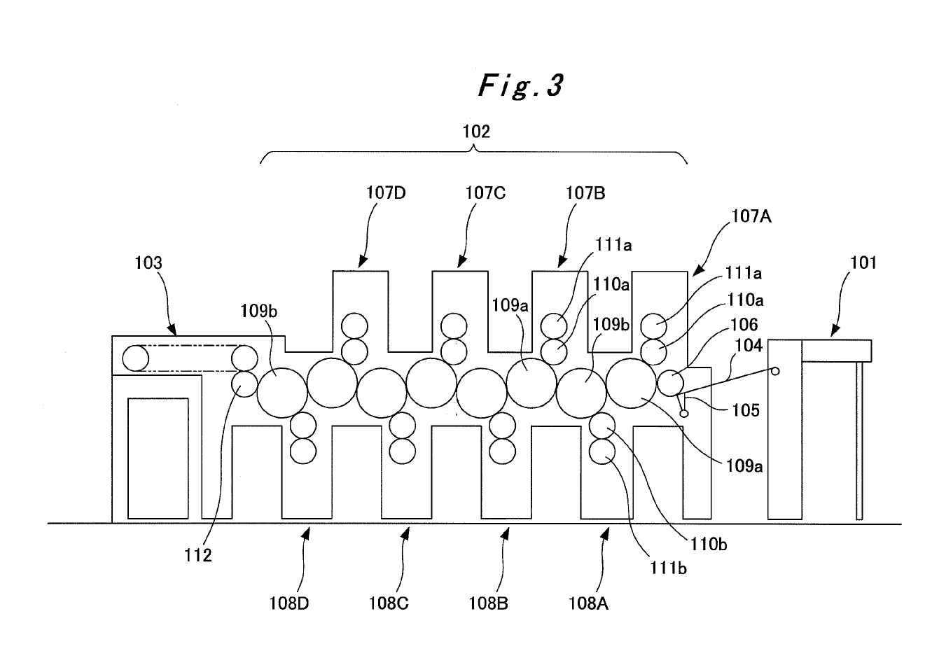

Firstly, FIG. 3 shows an example of a printing press provided with impression cylinders and a transport cylinder, for which a jacket according to the present invention is used. This printing press is a sheet-fed rotary printing press for making prints on the two sides of a sheet. The printing press includes a sheet feeder 101, a printing section 102, and a sheet delivery unit 103. Sheets of paper, which are stacked in the sheet feeder 101, are taken out therefrom sheet-by-sheet. Then, the sheets of paper thus taken out are fed to the printing unit 102 via a register board 104, a swing gripper 105, and a transfer cylinder 106.

The printing unit 102 includes four front-side printing units 107A, 107B, 107C, and 107D, and four back-side printing units 108A, 108B, 108C, and 108D. The front-side printing units 107A to 107D are provided respectively for first to fourth colors. Each of the front-side printing units 107A to 107D is constituted of an impression cylinder 109a, a blanket cylinder (a rubber cylinder) 110a, a plate cylinder 111a, and an inking device (not illustrated). The impression cylinder 109a is provided with a sheet gripper, while the blanket cylinder 110a, the plate cylinder 111a, and the inking device are provided on the upper portion of the impression cylinder 109a. In the same manner, the back-side printing units 108A to 108D are provided respectively for the first to fourth colors. Each of the back-side printing units 108A to 108D is constituted of an impression cylinder 109b, a blanket cylinder (a rubber cylinder) 110b, a plate cylinder 111b, and an inking device (not illustrated). The impression cylinder 109b is provided with a sheet gripper, while the blanket cylinder 110b, the plate cylinder 111b and the inking device are provided on the lower portion of the impression cylinder 109a.

The front-side printing units 107A to 107D and the back-side printing units 108A to 108D are sequentially connected to one after another in the following manner. Specifically, the back-side printing unit 108A of the first color is positioned next to the front-side printing unit 107A of the first color, and then the front-side printing unit 107B of the second color is positioned next to the back-side printing unit 108A of the first color.

A sheet of paper fed from the sheet feeder 101 is transferred to the impression cylinder 109a of the first front-side printing unit 107A. The transferred sheet is pressed by the impression cylinder 109a against the blanket cylinder 110a, so that a print of the first color is made on the front side of the sheet. Sequentially, the sheet is transferred to the impression cylinder 109b of the first back-side printing unit 108A. The transferred sheet is then pressed by the impression cylinder 109b against the blanket cylinder 110b, so that a print of the first color is made on the back side of the sheet. Thereafter, as in the same manner as that described above, prints of the second to fourth colors are alternately made on both of the front and back sides of the sheet of paper by the second to fourth front-side printing units 107B to 107D and the second to fourth back-side printing units 108B to 108D. After the printing is completed, the sheet of paper is transferred from the impression cylinder 109b of the last printing unit to the sheet delivery unit 103 via a transport cylinder 112, and is then delivered by the sheet delivery unit 103. Such a perfecting press is disclosed, for example, in Japanese Patent Application Laid-open Publication No. Hei 11-105249.

In such a perfecting press, each of the impression cylinders, other than the impression cylinder 109a positioned at the most upstream side, presses a side on which a print is made of a sheet against the corresponding blanket cylinder 110a or 110b. In other words, the side, to which ink is applied, of the sheet is pressed against the corresponding blanket cylinder 110a or 110b. Accordingly, the ink applied to the side adheres to the impression cylinder 109a or 109b. The ink having adhered to the impression cylinder 109a or 109b then adheres to the next printing product (the next sheet of paper). As a result, the printing product is smeared to be a failure.

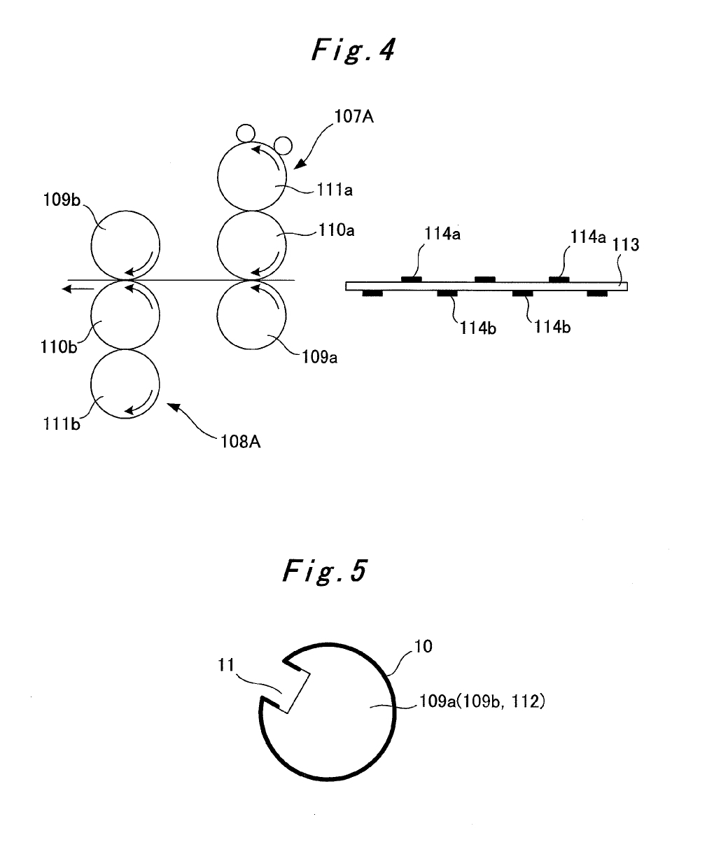

FIG. 4 schematically shows how a printing product is smeared with ink. Firstly, in the first front-side printing unit 107A, the front side of a sheet of paper 113 is pressed by the impression cylinder 109a against the blanket cylinder 110a, so that ink 114a is applied to the front side of the sheet of paper 113, that is, a print is made on the front side. Next, in the first back-side printing unit 108A, the back side of the sheet of paper 113 is pressed by the impression cylinder 109b against the blanket cylinder 110b, so that ink 114b is applied to the back side of the sheet of paper 113. At this time, part of the ink 114a applied to the front side of the sheet of paper 113 is transferred to the impression cylinder 109b. Then, the part of the ink 114a, having been transferred to the impression cylinder 109b, is transferred further to another sheet of paper that comes next. In this manner, the printing product is eventually smeared. Such a problem is not limited to the case of making prints by using a perfecting press, and may occur as well in the case of making a print on the back side of a sheet of paper by reversing the sheet of paper having a print made on the front side thereof by using a convertible perfecting press having a function of sequentially making prints on the front and back sides of a sheet of paper. In addition, although not as serious as the case of the impression cylinder 109b pressing the sheet of paper 113 against the blanket cylinder 109b, the same problem may occur in the transport cylinder (the transfer cylinder) 112, which transports the sheet of paper 113 in a state where a side, on which a print is made, of the sheet of paper 113 is in contact with the surface of the transport cylinder 112. Note that, the transport cylinder mentioned here includes an intermediate cylinder 110 that is shown in FIG. 2 of Japanese Patent Application Laid-open Publication Hei. 11-105249, and also an intermediate cylinder or a transfer cylinder which transports a sheet of paper between two impression cylinders of the respective printing units in a one-side printing press.

For the purpose of preventing such smearing of printing products from occurring, a technique as shown in FIG. 5 has been used. Specifically, a jacket 10, resistant to the adhesion of ink, is mounted on a surface of each of the impression cylinders 109a of the second and subsequent front-side printing units 107B to 107D, the impression cylinders 109b of all the back-side printing units 108A to 108D, and the transport cylinder 112.

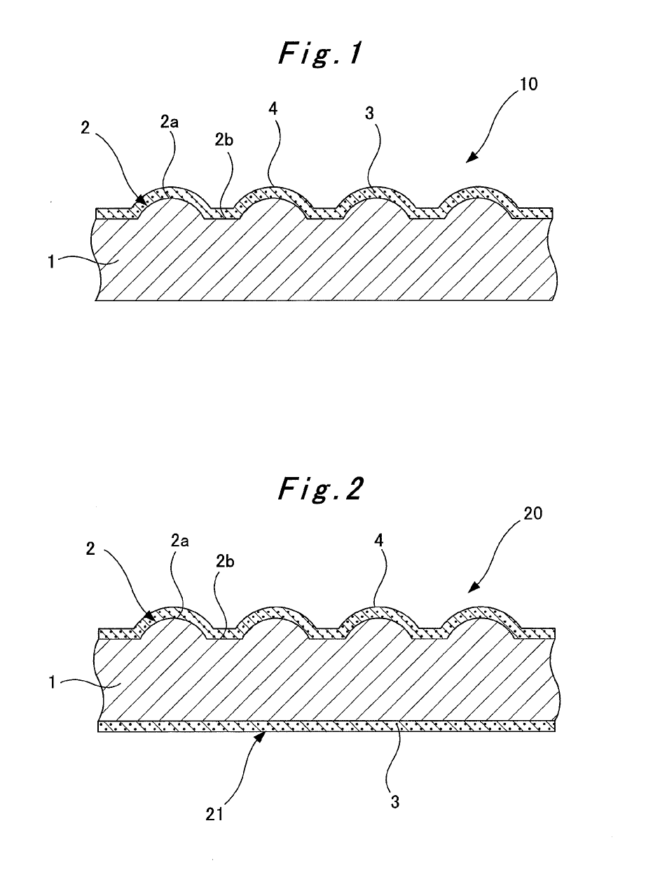

FIG. 1 shows an enlarged cross-section of a part of the jacket 10 according to a first embodiment of the present invention.

As shown in FIG. 1, convex and concave portions 2 having hemispherical convex portions 2a are formed on the surface of a sheet-shaped base 1. As the sheet-shaped base 1, used is a plate of stainless steel (for example, SUS304) or a plate of a metal having a wear resistance, such as aluminum. The convex and concave portions 2 on the surface of the base 1 are formed in a uniformly distributed manner by, for example, embossing using a roller. When the convex and concave portions 2 are formed by machining using a roller, the size of each convex portion 2a is made uniform. For the jacket 10 to be employed, the size of each convex portion 2a is 3 μm to 30 μm. When the size of each convex portion 2a is less than 3 μm, the surface roughness of the jacket 10 is too small. Accordingly, ink adheres to the surface of the jacket 10, so that the surface is smeared. On the other hand, when the size of each convex portion 2a is more than 30 μm, the surface roughness of the jacket 10 is too large. Accordingly, the tip of each convex portion 2a damages printing products themselves, such as paper and cloth, so that normal printing cannot be performed. The optimum size of each convex portion 2a is 10 μm to 20 μm.

The pitch (interval) between each adjacent two convex portions 2a in the convex and concave portions 2 is approximately 20 μm to 150 μm. When the pitch is too small, the contact area of the jacket 10 with a printing product is large, so that white spots are increased. When the pitch is too large, the jacket 10 is brought into direct contact with a printing product, so that ink smearing occurs, resulting in deterioration in the printing quality. Note that, since a line resolution of general printing products today is 175 lines per inch, there also is an intention to fulfill the demand for reducing the pitch below the space between such lines.

The roughness of the convex and concave portions 2 is determined, as will be described later, so that the surface roughness of the jacket 10 after the application of a nickel plating 4 to the surface of the convex and concave portions 2 can become 5 μm to 40 μm.

The electroless nickel plating 4, in which particles 3 each made of a modified fluororesin are dispersed as ink-repellent particles, is applied to the surface of the convex and concave portions 2. As the modified fluororesin, tetrafluoroethylene resin (PTFE) is used, for example. The nickel plating 4 covers the convex and concave portions 2 in a manner that the concave and convex profile of the convex and concave portions 2 is left. In other words, the nickel plating 4 is applied to the surface to an extent that concave portions 2b are not filled. Specifically, the plating 4 is applied thereto, so that the surface roughness Rz is 5 μm to 40 μm. The reason why the surface roughness Rz is set at 5 μm to 40 μm is as follows. When the surface roughness Rz is less than 5 μm, the contact area of the jacket 10 with a printing surface is large. Accordingly, ink may adhere to the surface of the jacket 10 to smear the jacket 10. On the other hand, when the surface roughness Rz is more than 40 μm, the tip of each convex portion 2a damages printing products themselves, so that normal printing cannot be performed. It is more preferable that the surface roughness Rz be 15 μm to 30 μm.

Examples of the modified fluororesin used as the ink-repellent particles 3 include, in addition to polytetrafluoroethylene resin (PTFE), tetrafluoroethylene-perfluorovinyl ether copolymer (PFA), tetrafluoroethylene-hexafluoropropylene copolymer (FEP), ethylene-tetrafluoroethylene copolymer (ETFE), polyvinylidene fluoride (PVDF), trifluorochloroethylene resin (PCTFE), and also graphite fluoride. Among these examples, PTFE is desirable as the material to be dispersed in the plating because the PTFE has the lowest surface energy (18 dyn/cm) among the solids, that is, the PTFE has the strongest ink repellency.

As the ink-repellent particles 3, artificial diamond may also be used instead of the modified fluororesin. The artificial diamond has a high hardness to be hardly worn. For this reason, the artificial diamond is preferable in view of the enhancement of the durability.

As the plating 4, in which the ink-repellent particles 3 are dispersed, for example, a plating of an alloy, such as nickel-phosphorus (Ni—P), nickel-boron (Ni—B), may be used instead of nickel plating. In the plating 4, the ink-repellent particles 3 are dispersed in the metal matrix in a volume ratio of 10% to 60%. The reason for setting the volume ratio of the particles in the metal matrix at 10% to 60% is as follows. When the volume ratio is less than 10%, the repelling force of the plating against ink is too weak. As a result, ink adheres to the surface of the plating, that is, the surface of the jacket, so that the jacket is smeared. On the other hand, currently, it is technically difficult to set the volume ratio at more than 60%.

The particle size of each ink-repellent particle 3 to be dispersed in the plating 4 may be 0.05 μm to 15 μm. It is technically difficult to set the particle size of each ink-repellent particle 3 at less than 0.05 μm, and also such particles are not available in the market. In other words, the lower limit is set at 0.05 μm because of technical and economical reasons in view of implementation. On the other hand, the upper limit is set at 15 μm because of the following reason. When the particle size is larger than 15 μm, the thickness of the plating becomes large while the surface roughness of the jacket 10 becomes small. Accordingly, ink adheres to the surface of the jacket 10 to smear the jacket 10. In addition, the modified fluororesin is relatively soft. In a case where the modified fluororesin is used as the ink-repellent particles 3, if the particle size is large, the strength of that portion is reduced. For this reason as well, it is desirable that the upper limit of the particle size be approximately 15 μm.

As described above, by applying, the nickel plating 4, in which the ink-repellent particles 3 are dispersed, to the surface of the convex and concave portions 2, the surface of the impression cylinder is caused to have a high hardness and be likely to keep ink away from the surface to easily repel ink therefrom. Moreover, the plating 4 may have a hardness of Hv300 or more, which is even equal to that of a general steel material, and also have a wear resistance. The increase in the film thickness of the plating 4 also makes it possible to achieve an improvement in the service life thereof. Because of the high hardness of the plating 4, paper dust and debris hardly stick into the surface thereof. Moreover, since the plating 4 is a metal, the plating 4 is conductive to be unlikely to be charged. As a result, the plating 4 is unlikely to absorb paper dust and debris.

When the jacket 10 obtained in the above-described manner is employed in the printing press shown in FIG. 3, the jacket 10 is mounted on each of the impression cylinders 109a of the second and subsequent front-side printing units 107B to 107D, the impression cylinders 109b of all the back-side printing units 108A to 108D, and the transport cylinder 112. The jacket 10 is mounted in a way as shown in FIG. 5, for example. Firstly, the two ends of the jacket 10 are inserted into a groove 11 of each of the impression cylinders 109a (109b) and the transport cylinder 112. Then, the jacket 10 is stretched and retained by a retaining device (not illustrated) that is provided in the groove 11.

Suppose a case where prints are made on the two sides of a sheet of paper by a printing press in which the jacket 10 is mounted on each of the impression cylinders and transport cylinder. In this case, when a sheet of paper is pressed against the blanket cylinder side, and when a sheet of paper is transported, the tip of each convex portion 2a is brought into contact with the sheet of paper. Since the convex portion 2a is brought into contact with the sheet of paper at the tip thereof, which is the minute point, even when ink after printing adheres to the convex portion 2a, the ink on the convex portion 2a is unlikely to smear a printing product that comes next, so that the printing quality is hardly influenced.

The using of the impression cylinder 109a, 109b, or the transport cylinder 112, on which the jacket 10 is mounted, makes it possible to prevent ink smearing from occurring over a long period of time. In other words, washing is required less frequently than the other cases, so that the print productivity can be improved. When smearing occurs in printing, the impression cylinder 109a, 109b or the transport cylinder 112 is to be washed. Even in this case, since the nickel plating is applied to the surface of the jacket 10, the washability is extremely good, so that the cylinder can be easily washed. Since the ink-repellent particles 3 are firmly retained by the metal matrix of the plating, the ink-repellent particles 3 are not removed or do not fall off by the washing. Moreover, even when the surface of the plating 4 is worn, the particles 3 under the surface are newly exposed to the outside, so that the ink repellency is maintained.

This jacket 10 makes it possible to achieve a semi-permanent service life of an impression cylinder unless an exceptional circumstance like breakdown arises, while the service life has been thought to be 15 to 30 million sheets to be printed.

It should be noted that the plating 4 can be removed from the base 1 in the jacket 10 by performing a process reverse to the above-described manufacturing process. This allows the base 1 to be reused for the reproduction of the jacket 10.

### Embodiment 2

FIG. 2 shows a cross-section of a part of a jacket for an impression cylinder or a transport cylinder, according to another embodiment.

In a jacket 20 according to this embodiment, an electroless nickel plating 21 having ink repellency is applied also to the back side of the base 1. The forming of the layer of the nickel plating 21 on the back side improves the slip characteristic of the jacket 20 to the surface of an impression cylinder or the like, on which the jacket 20 is mounted. Accordingly, when the jacket 20 is stretched to be mounted on a cylinder, it is possible to smoothly apply tension. As a result, a uniform adhesion of the jacket 20 to the cylinder is obtained. Since the ink-repellent particles 3, such as modified fluororesin particles, are dispersed in the plating 21, the self-lubricating property of the particles 3 improves the slip characteristic. Accordingly, the mountability of the jacket can be improved without increasing the number of manufacturing processes, by forming the nickel plating layer on the back side of the base 1, which is the same nickel plating layer as that on the front side of the base 1 as described above. When a commercially-available embossed plate is used as the base, the plating on the back side of the base is required.

In addition, the forming of the same nickel plating layers respectively on the two sides of the base 1 facilitates the manufacturing of the jacket in comparison to the case of applying the plating only on one side of the base 1 (because there is no need for covering the other side, to which no plating is applied). Moreover, this also eliminates the need for using SUS304 or the like having a high corrosion resistance as the material of the base 1.

In the jacket for an impression cylinder or a transport cylinder of a printing press according to the present invention, the metal plating having the ink-repellent particles dispersed therein is formed on the surface of the sheet-like base having convex and concave portions on the surface thereof. This makes it difficult for ink to adhere to the surface. In addition, since the metal plating has a high hardness and an excellent wear resistance, the paper dust and the like hardly stick into, and thus adhere to, the metal plating. Moreover, the metal plating provides, to the surface of the jacket, excellent washability and resistance to solvents. This facilitates the washing operation using a solvent at the time when the surface is smeared. Note that, the forming of the metal plating, having ink-repellent particles dispersed therein, on the back side of the base improves the slip characteristic of the jacket to the cylinder around which the jacket is wound. As a result, the mountability of the jacket on the cylinder is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A jacket for any one of an impression cylinder and a transport cylinder of a printing press, which jacket is wound around any one of an impression cylinder and a transport cylinder of a printing press so as to prevent ink from adhering to the cylinder, the jacket produced by plating the front side of a sheet-shaped base having convex and concave portions thereon with a metal having ink-repellent particles dispersed therein, in a manner that the convex and concave portions on the front side of the sheet-shaped base are left.

2. The jacket for any one of an impression cylinder and a transport cylinder of a printing press, according to claim 1, wherein the ink-repellent particles are made of a modified fluororesin.

3. The jacket for any one of an impression cylinder and a transport cylinder of a printing press, according to claim 2, wherein the modified fluororesin is one selected from the group consisting of tetrafluoroethylene resin, tetrafluoroethylene-perfluorovinyl ether copolymer, tetrafluoroethylene-hexafluoropropylene copolymer, ethylene-tetrafluoroethylene copolymer, polyvinylidene fluoride, trifluorochloroethylene resin, and graphite fluoride.

4. The jacket for any one of an impression cylinder and a transport cylinder of a printing press, according to claim 1, wherein the ink-repellent particles are artificial diamond.

5. The jacket for any one of an impression cylinder and a transport cylinder of a printing press, according to claim 1, wherein the back side of the sheet-like base is plated with a metal having ink-repellent particles dispersed therein.

6. The jacket for any one of an impression cylinder and a transport cylinder of a printing press, according to claim 1, wherein the metal for the plating is any one of nickel and a nickel alloy.

7. The jacket for any one of an impression cylinder and a transport cylinder of a printing press, according to claim 1, wherein the size of each convex portion of the convex and concave portions is 3 μm to 30 μm.

8. The jacket for any one of an impression cylinder and a transport cylinder of a printing press, according to claim 1, wherein the pitch of the convex portions of the convex and concave portions is 20 μm to 150 μm.

9. The jacket for any one of an impression cylinder and a transport cylinder of a printing press, according to claim 1, wherein the size of each ink-repellent particle is 0.05 μm to 15 μm.

10. The jacket for any one of an impression cylinder and a transport cylinder of a printing press, according to claim 1, wherein the surface roughness Rz of the jacket after the application of the plating is 5 μm to 40 μm.

11. The jacket for any one of an impression cylinder and a transport cylinder of a printing press, according to claim 1, wherein the plating has a hardness of Hv300 or more.
